(19) United States
(12) Patent Application Publication
(10) Pub. No.: US 2014/0209772 A1
(43) Pub. Date: Jul. 31, 2014

(54) APPARATUS FOR MAINTAINING SPACE CREATED BETWEEN VERTICALLY STACKED LOADS AND A METHOD OF USING SAME

(71) Applicant: STRAD ENERGY SERVICES LTD., Calgary (CA)

(72) Inventor: Paulie Ann YEATER, Fairmont, WV (US)

(73) Assignee: STRAD ENERGY SERVICES LTD., Calgary (CA)

(21) Appl. No.: 14/163,774

(22) Filed: Jan. 24, 2014

Related U.S. Application Data
(60) Provisional application No. 61/756,747, filed on Jan. 25, 2013.

(51) Int. Cl. B65G 59/00

(52) U.S. Cl. CPC B65G 59/005
USPC 248/346.01; 414/800

(57) ABSTRACT

A spacing tool and a method for facilitating the de-stacking of vertically stacked items are disclosed. The spacing tool comprises an attachment arm and a spacing arm pivotably coupled to a pivot. The attachment arm comprises one or more suitable fasteners for attaching the first arm to a load. The spacing arm is rotatable about the pivot between an open position and a support position. The pivot comprises a biasing mechanism for biasing the spacing arm to the support position. To create and maintain a clearance between an upper load and a lower load therebelow, one may rotate the spacing arm to the open position, and vertically attach the attachment arm to a side of either the upper load or the lower load such that the second arm rests against the other load. Then the upper load is lifted to create a space sufficient for the spacing arm to rotate, at which time the biasing mechanism automatically rotates the spacing arm to the support position for maintaining a clearance between the upper and lower loads.

### FIELD OF THE DISCLOSURE

The present disclosure generally relates to an apparatus and a method for maintaining space created between vertically stacked items, and in particular, a spacing tool for maintaining space between vertically stacked large and/or heavy items during de-stacking.

### BACKGROUND

Large and/or heavy items, such as loaded containers, lumber, boards, metal bars, tubes, pipes, or bundles thereof, are often vertically stacked or piled in storage or transportation to pack in a limited space as many items as allowed. To de-stack the vertically stacked or piled items, it is often necessary to create clearance or space between an item to be removed from the stack and the adjacent item therebelow to allow de-stacking equipment, such as forklift or human hands, to properly position under the item to be removed. The de-stacking equipment then lifts the item and removes it from the stack.

FIG. 1 illustrates an existing method for creating clearance or space between two vertically stacked items in some cases. As shown, spacers or “dunnage” 12, e.g., 2″ by 4″ or 4″ by 4″ lumber of proper length, are inserted between neighboring layers of items 14 when stacking the items. However, this method requires a large amount of spacers, the stock of which, and the transportation of which to the jobsite, increases the stacking and de-stacking cost. Moreover, this method generally increases the overall height and weight of the stack, and may not be desirable when space and/or weight allowance is limited.

Therefore, in many cases, items are vertically stacked without the insertion of spacers therebetween. When de-stacking, a top item to be removed from the stack is first raised at an end or corner thereof by using machinery or human strength, and a spacer is inserted at the raised end between the item to be removed and the adjacent item therebelow. The raised end is then put down to rest on the spacer. This procedure is optionally repeated at another end or corner until space sufficient for the de-stacking equipment to use is properly created between the item to be removed and the adjacent item therebelow. The de-stacking equipment then lifts the item to be removed, and removes it from the stack. After the top item is removed, the spacers are removed from the stack so that they can be used for removing the next item.

Thus, more items may be stored in a space and/or weight limited location, and much fewer spacers are required. However, this method generally requires a person to move close to the partially raised but unbalanced item as well as the de-stacking equipment to manually place spacers, which places the personnel at the risk of injury.

Therefore, there is a need to develop a portal tool for facilitating the de-stacking of vertically stacked items.

### SUMMARY

According to one aspect of this disclosure, an apparatus for maintaining a clearance created at an interface between vertically stacked first and second loads is disclosed. The apparatus comprises a first arm having a load-attachment surface extending from a pivot, and a second arm rotatable relative to the first arm about the pivot. The second arm has opposing first and second support surfaces forming a height therebetween, and is normally biased for rotation about the pivot towards the first arm's load-attachment surface between an open position, away from the first arm's load-attachment surface, and a supporting position, towards the first arm's load-attachment surface. The first arm is attachable at a side of the first load with the pivot located at the interface, with second arm biased against the second load when the second arm is at the open position, and the second arm is rotatable to the supporting position into the clearance created at the interface for maintaining a clearance equivalent to said height between the first and second loads.

In various embodiments, the biasing mechanism may be a spring, an elastic, a rubber band, or the like. The biasing mechanism may be in the pivot, or alternatively secured to both the first and second arms.

The second arm may be a spacing block providing the height for maintaining the clearance. The spacing block may be made of wood, metal, plastic, rubber, Fibre-reinforced plastics (FRP), or the like. The cross-section of the spacing block, as viewed along an axis of the pivot, may be a rectangle, triangle, circle or other suitable shapes. The first and second support surfaces of the second arm may be of the same or different shapes and/sizes, depending on the design in various embodiments.

The first arm further comprises one or more fasteners for attaching the first arm to a side of the first or second load. According to an aspect of this disclosure, the fasteners may be nonintrusive fasteners that do not intrude into a load for attaching the first arm to a load without intruding into the load. Such nonintrusive fasteners may be magnet for attaching the first arm to a side of a ferromagnetic load, suction cups for attaching the first arm to a generally smooth side surface of a load, or a wedge, thin plate or spike for inserting in the interface between two vertically neighboring sub-loads. According to another aspect of this disclosure, the fasteners may be intrusive fasteners such as screws, spikes, sharp extrusions or the like that intrude into a load for attaching the first arm thereto.

According to another aspect of this disclosure, the first and/or second loads comprises one or more sub-loads, and the apparatus further comprises a mount extending from the first arm and spaced from the pivot for securing the load-attachment surface of the first arm against the side of the load with the pivot located at the interface.

According to another aspect of this disclosure, the second load is on top of the first load. According to yet another aspect of this disclosure, the first load is on top of the second load.

According to another aspect of this disclosure, a method for maintaining a clearance created at an interface between vertically stacked first and second loads is disclosed, the method comprising:

providing a first spacing tool having a first arm and a second arm coupled at a pivot for rotation therebetween;

locating the pivot of the first spacing tool at the interface;

attaching the first arm of the first spacing tool at a side of the first load, the second arm of the first spacing tool cocked to an open position biased towards the second load;

separating the first and second loads to form a clearance at least about the location of the first spacing tool;

urging the second arm of the first spacing tool to a supporting position into the clearance; and

reducing the clearance until the upper of the first and second loads is supported upon the second arm of the first spacing tool for maintaining the clearance between the first and second loads.

According to another aspect of this disclosure, the method further comprises: cocking the second arm of the first spacing tool to an open position; attaching the first arm of the first spacing tool to the lower load with the pivot of the first spacing tool located at the interface and the second arm of the first spacing tool biased against the upper load; and lifting the upper load until the second arm of the first spacing tool rotates to the supporting position.

According to another aspect of this disclosure, the method further comprises: cocking the second arm of the first spacing tool to an open position; attaching the first arm of the first spacing tool to the upper load with the pivot of the first spacing tool located at the interface and the second arm of the first spacing tool biased against the lower load; and lifting the upper load and attached first spacing tool until the second arm of the first spacing tool rotates into the clearance.

According to another aspect of this disclosure, the method further comprises: attaching the first arm of the first spacing tool at a side of the first load with fasteners.

According to another aspect of this disclosure, the method further comprises: attaching the first arm of the first spacing tool at a side of the first load with magnets.

According to another aspect of this disclosure, the attaching of the first arm is temporary. The de-stacking tool may be removed after the upper load is removed from the stack.

According to another aspect of this disclosure, the method further comprises:

providing a second spacing tool having a first arm and a second arm coupled at a pivot for rotation therebetween;

locating the pivot of the second spacing tool at the interface;

attaching the first arm of the second spacing tool at a side of one of the first and second loads, the second arm of the second spacing tool cocked to an open position biased towards the other of the first and second loads;

separating the first and second loads to form a clearance at least about the location of the second spacing tool;

urging the second arm of the second spacing tool to a supporting position into the clearance; and

reducing the clearance until the upper of the first and second loads is supported upon the second arm of the second spacing tool for maintaining the clearance between the first and second loads.

According to another aspect of this disclosure, the first arm of the second spacing tool is attached to a side of one of the first and second loads after the first and second loads have been separated to form a clearance at least about the location of the first spacing tool.

According to another aspect of this disclosure, the first arm of the second spacing tool is attached to a side of one of the first and second loads before the first and second loads have been separated to form a clearance at least about the location of the first spacing tool, and the first and second loads are separated to form a clearance at least about the locations of both the first and the second spacing tools.

### BRIEF DESCRIPTION OF THE DRAWINGS

FIG. 1 illustrates a prior art method for creating clearance or space between two vertically stacked items;

FIG. 2A is a perspective view of a spacing tool in the support position according to one embodiment;

FIGS. 2B to 2D are side, front and rear views of the spacing tool of FIG. 2A, respectively;

FIG. 2E is a perspective view of the spacing tool of FIG. 2A in the open position;

FIG. 2F is a side view of the spacing tool of FIG. 2A in the open position;

FIG. 2G is a side view of the spacing tool of FIG. 2A in the support position for maintaining the created clearance;

FIG. 3 is a flowchart showing the steps of a method of de-stacking vertically stacked loads using one or more spacing tools of FIG. 2A;

FIG. 4 is a detailed flowchart of the clearance creation step of FIG. 3;

FIGS. 5A to 8B illustrate upper and lower loads manipulated in accordance with the steps of FIG. 3;

FIGS. 9A and 9B illustrate using an additional spacing tool near a second end of an upper load to maintain a clearance through the entire extent of the upper load;

FIGS. 10A to 10D illustrate a method of attaching a spacing tool to an end of an upper load for maintaining a clearance, according to an alternative embodiment;

FIGS. 11A and 11B illustrate using the spacing tools for maintaining a clearance under an upper load that consists of a plurality of items as a group;

FIGS. 12A to 12D illustrate a method of using the spacing tool to maintain a clearance, according to another embodiment;

FIG. 13 shows a spacing tool wherein the attachment block is a wood plate having a magnetic metal piece embedded therein, according to yet another embodiment;

FIG. 14 shows a spacing tool wherein the attachment leaf is mounted to the attachment block such that the attachment leaf is in contact with a load when the spacing tool is attached thereto, according to still another embodiment;

FIG. 15 shows a spacing tool wherein the attachment block comprises one or more spikes or screws for attaching the spacing tool to a load, according to yet still another embodiment;

FIG. 16 shows a spacing tool wherein the attachment block comprises one or more sharp extrusions or teeth for attaching the spacing tool to a load, according to another embodiment;

FIG. 17 shows a spacing tool wherein the attachment block comprises a wedge, thin plate or spike for inserting in-between two sub-loads, according to another embodiment;

FIG. 18 shows a spacing tool wherein the spacing leaf is mounted to the first support surface of the spacing block such that, at the support position, the spacing leaf is generally perpendicular to the load-attachment surface, according to another embodiment;

FIGS. 19A and 19B illustrate a spacing tool wherein the spacing block is mounted on the back side of the spacing leaf, such that the spacing leaf is closer to the attachment side than the spacing block, according to another embodiment;

FIGS. 20A and 20B illustrate a spacing tool wherein the spacing leaf is mounted in the spacing block, according to another embodiment;

FIGS. 21A and 21B illustrate a spacing tool having a cylindrical spacing block at the open and support positions, respectively, according to another embodiment;

FIGS. 22A and 22B illustrate a spacing tool having a conical or frustum spacing block at the open and support positions, respectively, according to another embodiment;

FIGS. 23A and 23B illustrate a spacing tool having a spherical spacing block at the open and support positions, respectively, according to another embodiment; and

FIGS. 24A and 24B illustrate a spacing tool having a spring secured to the spacing arm and the attachment arm, according to another embodiment

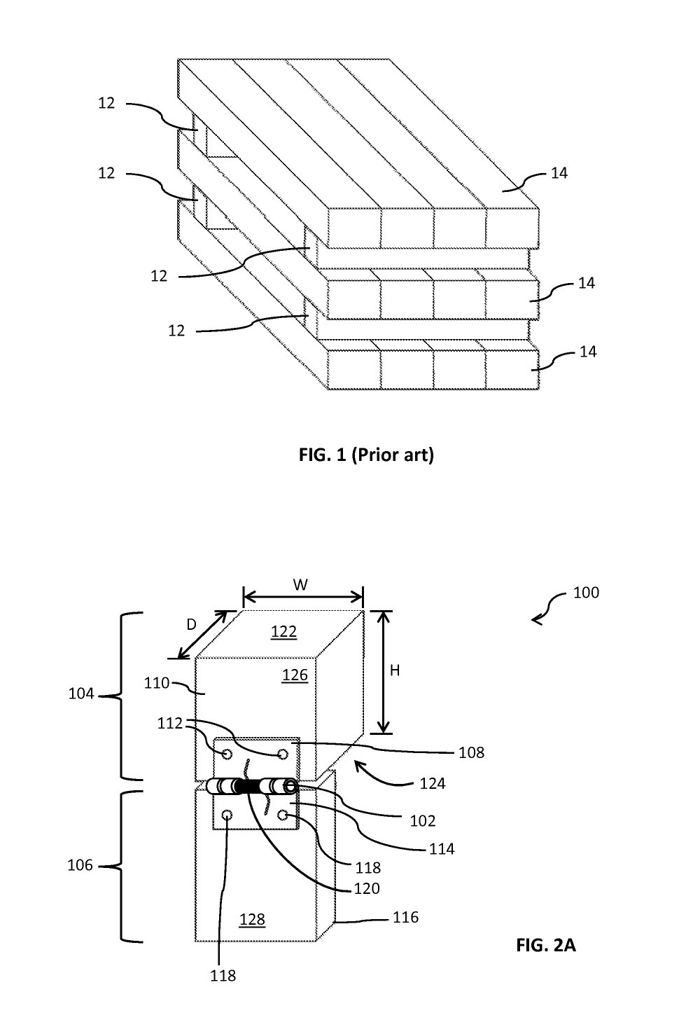

### DETAILED DESCRIPTION

This disclosure discloses a portable spacing tool as a de-stacking aid for maintaining clearance created between vertically stacked loads. Examples of such stacked loads include a plurality of stacked planer rig mats, sheets and beams. Herein, a “load” refers to one item or a plurality of vertically stacked sub-loads in a stack that may be lifted or removed therefrom as a group. In the following the load to be lifted or removed from the stack is denoted as the upper load, and the load below the upper load is denoted as the lower load.

One may first attach the spacing tool at a side of the upper load or the lower load, and then separate the loads to create sufficient clearance between the upper load and the lower load. When the clearance is reduced again, such as by lowering the upper load, the spacing tool automatically maintains that clearance without having to manually insert a block, spacer or dunnage therebetween. Thereafter, one can readily use de-stacking equipment to lift and remove the upper load from the stack.

Generally, the spacing tool is a hinged apparatus having a spacing arm and an attachment arm pivotably coupled at adjacent ends via a pivot. The attachment arm comprises one or more fasteners for attaching the attachment arm at a side of a load with the pivot located at an interface between the upper and lower loads. The spacing arm is rotatable about the pivot and is initially cocked in an open position, which allows the attachment arm to be attached to a load. The spacing arm is rotatable to a support position. When the spacing arm is rotated into a clearance created between the upper and lower loads, the spacing arm supports and maintains a clearance between the two loads. A biasing mechanism urges the spacing arm into the support position.

One may configure a spacing arm to the open position by overcoming the biasing force of the pivot, cocking the spacing arm, orienting the spacing tool in a vertical orientation and attaching the attachment arm at a side of a load such as the lower load. The spacing arm then rests against the other of the loads, such as the upper load, until the sufficient clearance is created for the spacing arm to rotate thereinto. The biasing mechanism urges the spacing arm to rotate to the support position and reside between the upper and lower loads. When the lifted upper load is lowered onto on the spacing arm, the spacing tool maintains a clearance by supporting the upper load upon the spacing arm and transferring weight imposed by the upper load, through the spacing arm, to the lower load. One or more spacing tools are used as necessary to space the upper load from the lower load.

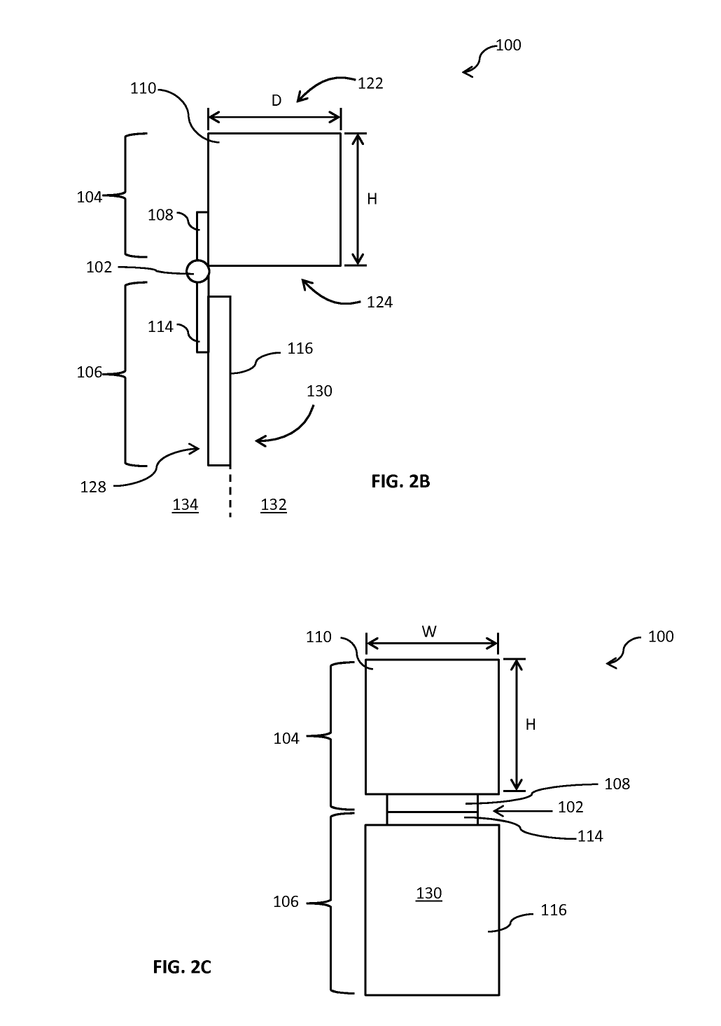

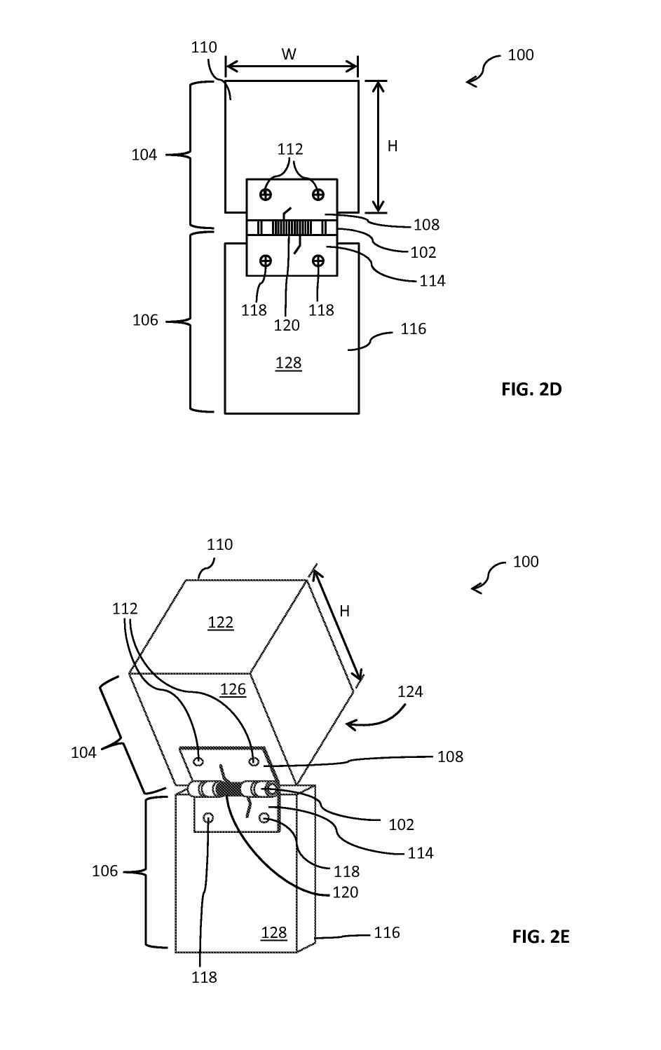

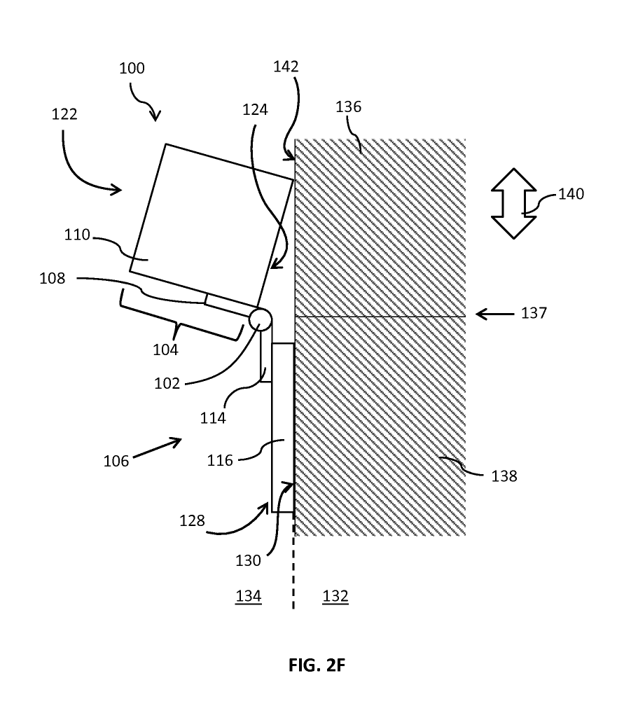

With reference to FIGS. 2A to 2D, a spacing tool 100 comprises a spacing arm 104 and an attachment arm 106 pivotably coupled at adjacent ends at pivot 102. The pivot 102 can include a biasing mechanism 120 for urging the spacing arm 104 to rotate to the support position.

In this embodiment, the pivot 102 is a spring hinge having a spacing leaf 108 and an attachment leaf 114, the biasing mechanism 120 comprising a spring in the hinge. The spacing arm 104 is formed by the spacing leaf 108. For ease and flexibility of setting the clearance height provided by the tool 100, the spacing arm 104 further comprises a spacing block 110 that is secured to the spacing leaf 108 using suitable fasteners 112 such as screws, nails, glue, barbs, nuts and bolts, or the like.

The attachment arm 106 is formed by the attachment leaf 114 and, if of insufficient extent to permit ready attachment, is further provided with an attachment block 116 that is mounted to the attachment leaf 114 using suitable fasteners 118 such as screws, nails, glue, barbs, nuts and bolts, or the like.

The spacing block 110 is a cubic block having a mounting surface 126 for mounting to the spacing leaf 108, a first support surface 124 for engaging one of the upper or lower load, and a second support surface 122 for engaging the other of the lower or upper load. Being perpendicular to the mounting surface 126, the first and second support surfaces 124, 122 are generally parallel and spaced apart a distance H for maintaining a clearance suitable for access by conventional de-stacking equipment.

As will be described in more detail later, the initial positioning and attachment of the attachment arm 106 dictates which of the first and second support surfaces 124 and 122 ultimately engage which of the upper or lower loads in the support position.

The spacing block 110 is made of a material with at least a sufficient compressive strength to support the anticipated loads. Such block material can be wood, metal, plastics such as epoxy resins, polyvinyl chloride (PVC), High-Density Polyethylene (HDPE), Fibre-reinforced plastic (FRP), or the like.

The attachment block 116 is a structure having a mounting surface 128 for mounting to the attachment leaf 114 and a load-attachment surface 130 on the opposite side thereof for facing or contacting a surface of the load when the attachment block 116 is attached thereto. The attachment block 116 comprises one or more suitable fasteners for attaching the attachment block 116 to a load. Those skilled in the art appreciate that the one or more suitable fasteners are determined by the designed use of the spacing tool 100, and shall match the properties of the load. For example, in this embodiment, the spacing tool 100 is used for creating clearance between vertically stacked loads having steel or other ferromagnetic sides, and thus the attachment block 116 can be a magnetic metal plate providing a magnetic field for attaching the spacing tool 100 to a steel load. Loads having wood or other similar periphery or sides are amenable to attachment using other fasteners, which are described in more detail later.

As better illustrated in FIG. 2B, the load-attachment surface 130 of the attachment arm defines an attachment side 132, which is the same side of the load-attachment surface 130, and a back side 134, which is the side opposite to the attachment side 132. At the support position, a substantial portion of the spacing arm 104 and, in turn, at least a substantial portion of the supporting surfaces 124 and 122, are on the attachment side 132.

The spacing arm 104 is initially manipulated or cocked to rotate from the support position, against the bias of the pivot 102, to an open position to enable attaching of the attachment arm 106 to the load with the pivot 102 aligned with the intended clearance.

As shown in FIGS. 2E and 2F, upper load 136 is initially and normally vertically stacked on lower load 138 forming an interface 137 therebetween. Attachment block 116 is attached to the lower load 138 with the pivot 102 located at about the interface 137. The user rotates the spacing arm 104, to the open position, the spacing arm 104 being rotated from an unrestrained position, normally on the attachment side 132 of the tool, allowing the attachment arm 106 to be attached to a side of the lower load 138. The spacing arm 104 is cocked in the open position with the spacing block 110 biased against a side 142 of the upper load 136.

As shown in FIG. 2G, when the upper load 136 is lifted or otherwise moved along a vertical path 140 to form a clearance at the interface 137, the spacing arm 104, and in particular, the spacing block 110, drags along the side 142 of the upper load 136 until the spacing arm 104 is no longer supported, the created clearance being sufficient to permit the spacing block to fit between the separated loads. The biasing mechanism 120 then urges the spacing arm 104 and block 110 to the support position.

In the support position, at least a substantial portion of the spacing block 110 has rotated to the attachment side 132 and into the clearance 144. The first support surface 124 engages the lower load 138 and the second support surface 122 engages the upper load 136, supporting the upper load 136 and maintaining the required clearance equivalent to height H for aiding in de-stacking and removing the upper load 136 from the stack.

The dimensions of the spacing block 110 determine the height H of the clearance and the stability of supporting the load on top thereof. For the ease of description, in the following, the height H, depth D and width W of the spacing block 110 are defined as those when the spacing arm 104 is rotated to the support position. Referring back to FIGS. 2A to 2D, as oriented in the support position, the height H of the spacing block 110 is the vertical length thereof in the support position, the depth D of the spacing block 110 is the horizontal length of the spacing block 110 along a direction perpendicular to the axis of the pivot 102, and the width W of the spacing block 110 is the horizontal length of the spacing block 110 measured along the axis of the pivot 102. The height, depth and width of the attachment block 112 if used may also be defined in a similar manner.

The height H of the spacing block 110, between the first and second support surfaces 124 and 122 determines the clearance to be maintained between two adjacent loads, which is of a dimension sufficient for access by de-stacking equipment. The width W of the spacing block 110 is one aspect of load support stability along the horizontal direction of the axis of the pivot 102, having a width sufficient for providing stable load support.

Referring again to FIG. 2G, in this embodiment, only a majority of the depth D of spacing block 110 is on the attachment side 132 when the spacing arm 104 is rotated to the support position. The depth D′ of such a portion, which is the difference between the depth D of the spacing block 110 and that of the attachment block 116, is one aspect of the load support stability along the horizontal direction perpendicular to the axis of the pivot 102, and is of a length sufficient for providing stable load support. In this embodiment, the spacing block 110 has similar height H, depth D and width W, for example, a 4″ by 4″ by 4″ wood cube. The attachment block 116 is a magnetic metal plate with a depth of ¼″.

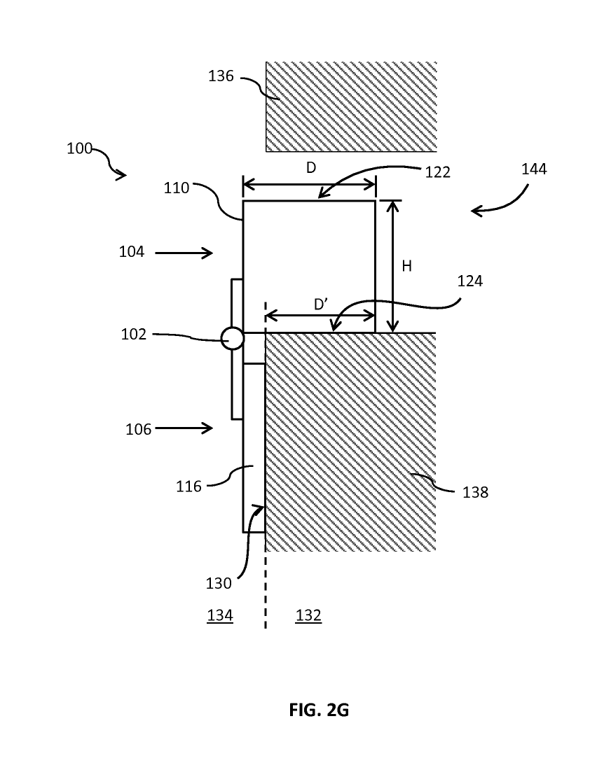

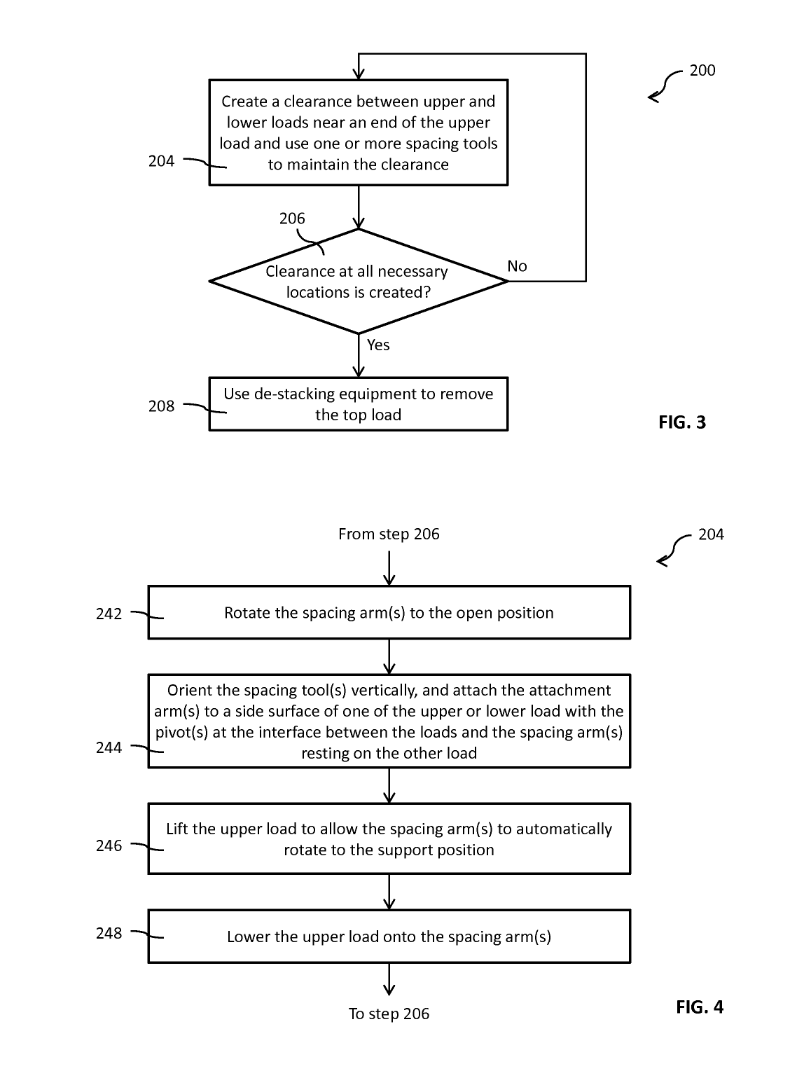

FIG. 3 is a flowchart showing the steps of a method 200 of de-stacking vertically stacked loads using one or more spacing tools 100. Usually, spacing tools 100 are temporarily attached to stacked loads for maintaining created clearance, and are removed from the loads after the load supported by the spacing tools 100 is removed from the stack.

With the method 200, a person first creates a clearance between an upper load and a lower load, being the load immediately below the upper load, and uses a spacing tool 100 to maintain the clearance (step 204). Then, the person determines if clearance at all necessary locations has been created (step 206). Such determination depends on the actual use scenario. For example, if the upper load is an extended member, such as a construction stud that has a width comparable to the dimension of the spacing tool 100, only one or perhaps two spacing tools 100 may be required, each at a location near an end of the upper load. If the upper load has a large planer surface, such as a sheet or mat having width much wider than the dimension of the spacing tool 100, both end-to-end and side-to-side spacing tools 100, for example four spacing tools 100, may be required, each at a location near a corner of the upper load. As another example, if the de-stacking equipment is able to exploit uneven clearance to remove the upper load, one spacing tool 100 located near one end of the upper load may be sufficient.

If at step 206, it is determined that clearance has not been created at all necessary locations, the process goes back to step 204 to use another spacing tool 100 to create clearance at the next location. If at step 206, it is determined that clearance at all necessary locations has been created, de-stacking equipment is then used to exploit the created clearance and remove the upper load from the stack.

FIG. 4 shows the detail of the step 204 that uses a spacing tool 100 to create clearance under an upper load. The location of the clearance to be created may be any location along a side of the upper load, e.g., near an end of the upper load or towards the middle thereof, as the operator deems appropriate. As shown, the spacing arm 104 of the spacing tool 100 is first rotated to the open position (step 242). Then, the spacing tool 100 is oriented to a generally vertical orientation, and the attachment arm 106 is attached to a side surface of one of the upper or lower load with the load-attachment surface 130 of the spacing tool 100 is in contact with, or facing, the side surface of the load, at a location along the upper load where clearance is to be created (step 244), such that the pivot 102 of the spacing tool 100 is about the interface between the upper and lower loads, and the spacing arm 104 rest against a side surface of the other load. Then, a force, a mechanical force or manpower, is applied to the upper load to lift the upper load at least at a side about the spacing tool (step 246). When the upper load is lifted to a height sufficient for the spacing arm 104 to rotate, the biasing mechanism 120 of the pivot 102 automatically rotates the spacing arm 104 to the support position such that the spacing block 110 is positioned between the upper and lower loads. The upper load is then lowered to rest on the spacing block 110 (step 248).

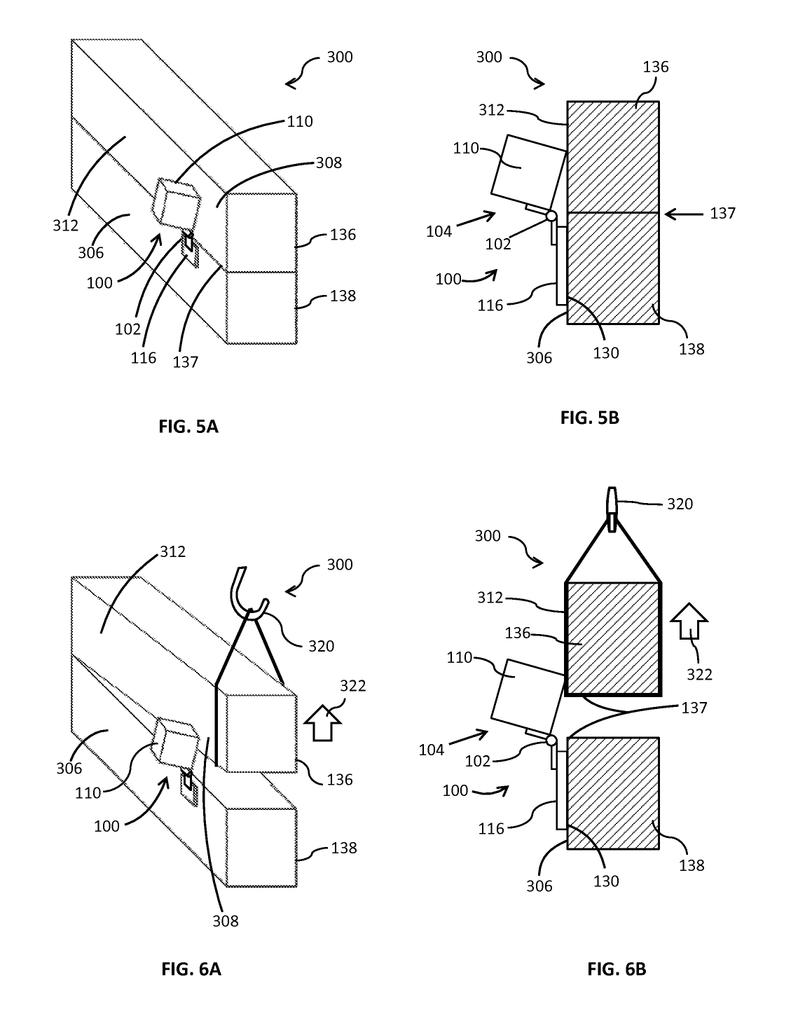

FIGS. 5A to 8B illustrates an example of the method 204 that uses a spacing tool 100 to create clearance between an upper load and a lower load, wherein FIGS. 5A, 6A, 7A and 8A are perspective views of a stack of loads at various stages, and FIGS. 5B, 6B, 7B and 8B are corresponding side views thereof, respectively. For the ease of illustration, the stack 300 in this example only comprises an upper load 136 and a lower load 138, both of which are steel studs.

As shown in FIGS. 5A and 5B, after the spacing arm 104 of the spacing tool 100 is rotated to the open position, the spacing tool 100 is oriented to a generally upright orientation (i.e., being generally vertically oriented with the spacing arm 104 above the attachment arm 106), and the attachment arm 106 is attached to the lower load 138 on the longitudinal side 306 thereof near a first end 308 of the upper load 136 and at a height that the pivot 102 is about the interface 137 between the upper and lower loads 136 and 138. The magnetic attachment plate 116 attaches the spacing tool 100 to the lower load 138 such that the load-attachment surface 130 of the spacing tool 100 is in contact with the side surface 306 of the lower load 138. The biasing mechanism (not shown) in the pivot 102 forces the spacing block 110 to rest against the side surface 312 of the upper load 136.

As shown in FIGS. 6A and 6B, a mechanical force 320 is used to lift the first end 308 of the upper load 136. As the spacing arm 104 is at the open position, the spacing block 110 does not block the vertical movement 322 of the upper load 136. As the attachment plate 116 has been attached to the lower load 138, the spacing block 110 slides on the surface 312 of the upper load 136 when the end 308 of the upper load 136 is moving up.

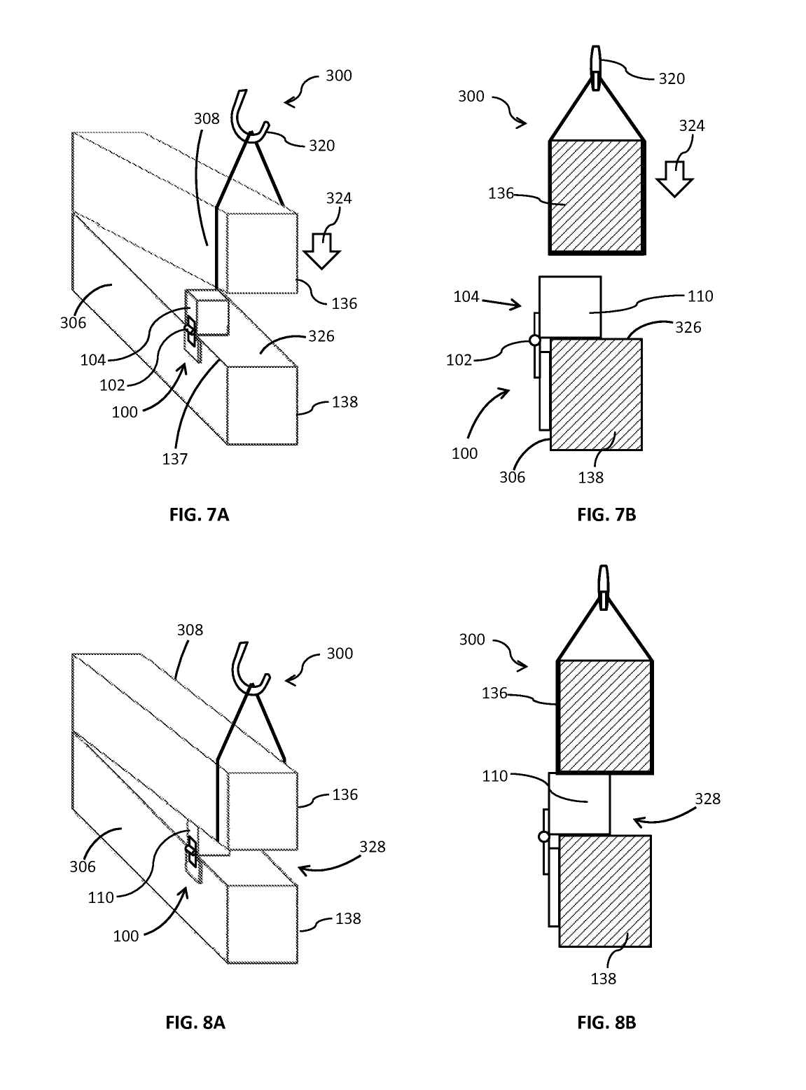

As shown in FIGS. 7A and 7B, when the first end 308 of the upper load 136 is lifted to a height that provides a clearance sufficient for the spacing arm 104 to rotate, the spacing arm 104 is urged to rotate about the pivot 102 to the support position. As the pivot 102 is located at the interface 137 at about the upper edge of the lower load 138, the spacing block 110 thus lands on the top surface 326 of the lower load 138.

The mechanical force 320 then lowers the first end 308 of the upper load 136. As the spacing arm 104 is now at the support position, the spacing block 110 blocks the vertical moving path 324 of the upper load 136. As shown in FIGS. 8A and 8B, the upper load 136 eventually rests on the spacing block 110. A clearance 328 between the upper load 136 and the lower load 138 near the end 308 is then maintained.

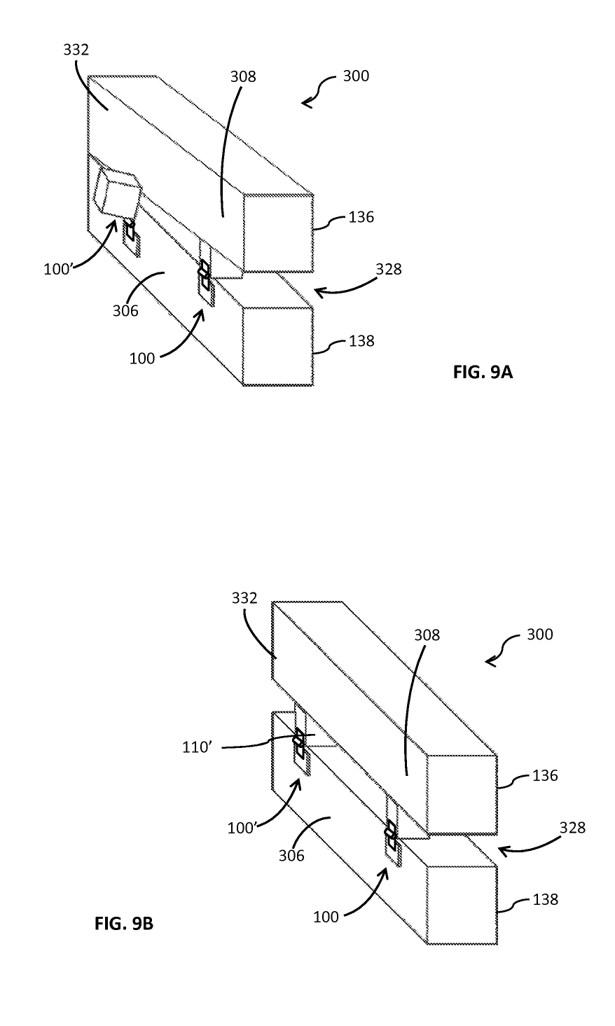

For separating elongated upper and lower loads along their extent, similarly, as shown in FIGS. 9A and 9B, another spacing tool 100′ may be used near a second end 332 of the upper load 136 to create a clearance 328 through the entire longitude of the upper load 136. De-stacking equipment such as a forklift may then be used to remove the upper load 136 from the stack 300.

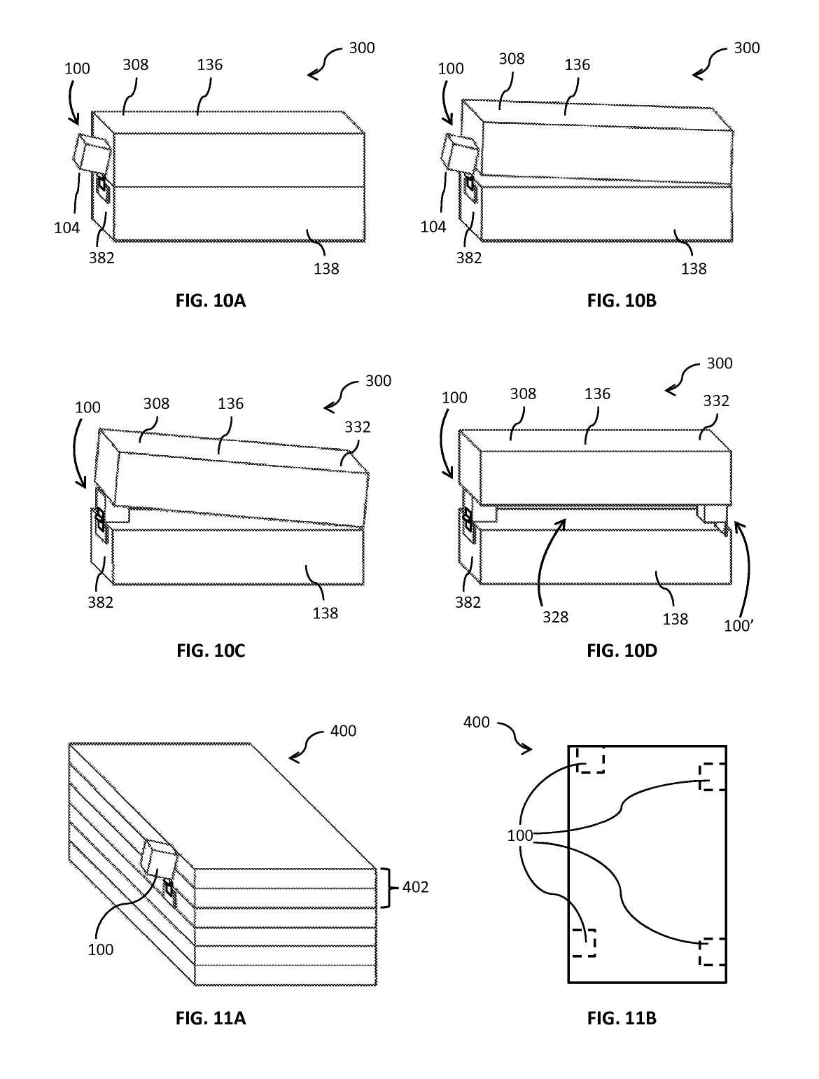

Persons skilled in the art appreciate that, alternatively, a spacing tool may be attached to an end surface of an upper load for creating clearance, as illustrated in FIGS. 10A to 10D. As shown, a spacing tool 100 may be configured to rotate its spacing arm to the open position, and attached to an end surface 382 of the lower load 138. Following the above procedure, the corresponding end 308 of the upper load 136 is then lifted by a mechanical force (not shown) to allow the spacing arm 104 of the spacing tool 100 to automatically rotate to the support position. The end 384 of the upper load 136 is then lowered and rests on the spacing arm 104. Similarly, another spacing tool 100′ can be configured to rotate its spacing arm to the open position and attached to the other end surface of the lower load 138. The corresponding end 332 of the upper load 136 is lifted and, after the spacing arm of the spacing tool 100′ automatically rotates to the support position, put on top thereof. A clearance 328 is then created between the upper load 136 and the lower load 138.

As described above, a load may consist of a plurality of items as a group. FIGS. 11A and 11B illustrate such an example. In this example, the stack 400 comprises a plurality of steel boards, spacing tools 100 are used to create clearance between a load 402, which comprises multiple boards as a group to be removed, and the board thereunder. Because of the large horizontal dimension of the boards, four individual spacing blocks, each positioned near a corner of the board, are used to create even clearance under the load 402, as shown in FIG. 11B.

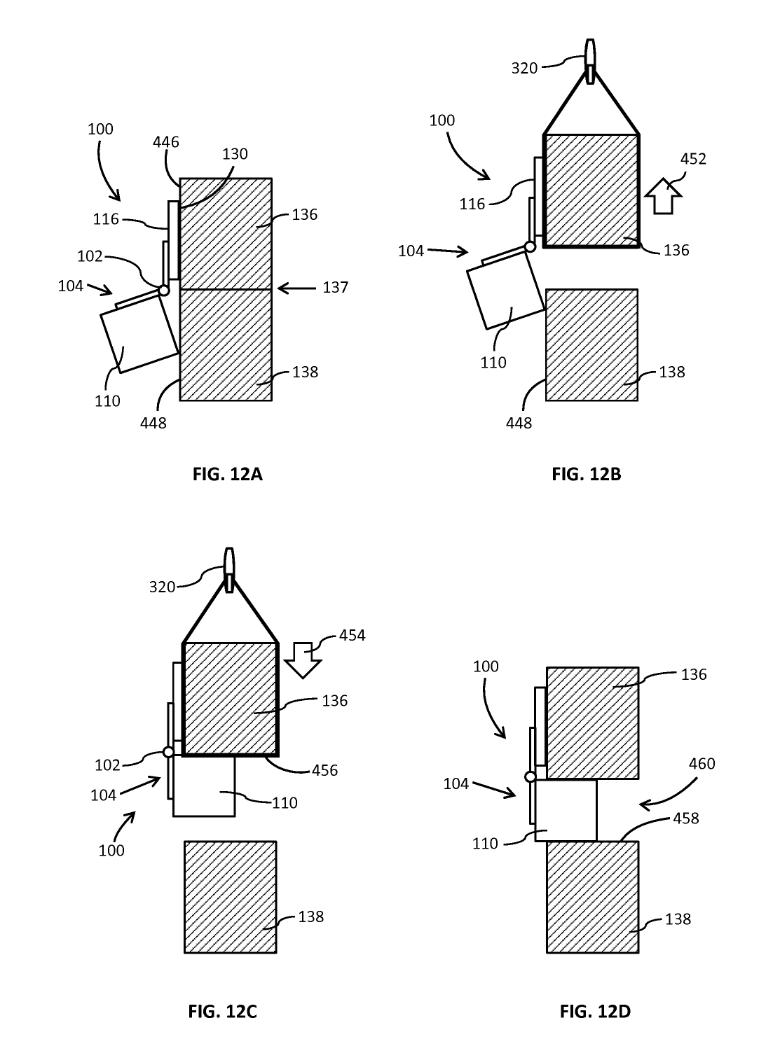

Other embodiments are also readily available. FIGS. 12A to 12D illustrate a method of using the spacing tool 100 to create clearance according to an alternative embodiment. In this embodiment, the spacing tool 100 is oriented “upside-down”, i.e., generally vertically oriented with the attachment plate 116 above the spacing block 110.

As shown in FIG. 12A, the spacing tool 100 is configured to rotate its spacing arm to the open position, and the attachment plate 116 thereof is attached to a side surface 446 of the upper load 136 near an end thereof with the pivot 102 positioned about the interface 137 between the upper and lower loads 136 and 138. The magnetic attachment plate 116 forces the load-attachment surface 130 of the spacing tool 100 in contact with the surface 446 of the upper load 136. The biasing mechanism 120 of the spacing tool 100 forces the spacing block 110 to rest against the side surface 448 of the lower load 138.

As shown in FIG. 12B, a mechanical force 320 is used to lift up the end of the upper load 136. As the spacing arm 104 is at the open position, it does not block the moving path of the upper load 136, as indicated by the arrow 452. Since the attachment plate 116 has been attached to the upper load 136, the spacing block 110 slides on the surface 448 of the lower load 138 when the end of the upper load 136 is lifting up.

As shown in FIG. 12C, when the end of the upper load 136 is lifted to a height sufficient for the spacing arm 104 to freely rotate, the biasing mechanism 120 automatically rotates the spacing arm 104 to the support position. Since the pivot 102 is at the interface 137 about the lower edge of the upper load 136, the spacing block 110 thus lands on the bottom surface 456 of the upper load 136.

The mechanical force 320 then lowers the end of the upper load 136, as indicated by the arrow 454. As the spacing tool 100 is attached on the upper load 136, it also moves down. As shown in FIG. 12D, the spacing block 110 eventually lands on the top surface 458 of the lower load 138, and a clearance 460 between the upper load 136 and the lower load 138 is then maintained.

In above embodiments, multiple spacing tools are used sequentially, wherein a next spacing tool 100′ is attached to a load after a previous tool 100 has been used to create and maintain a clearance. In an alternative embodiment, when multiple spacing tools 100 are needed, the multiple spacing tools 100 are configured to the open position and are all attached to appropriate locations of a load, and then the upper load is lifted to a height sufficient for all of the multiple spacing tools 100 to automatically configure to the support position. The upper load is then lower to rest upon the multiple spacing tools 100.

Those skilled in the art appreciate that, when multiple spacing tools 100 are used, the multiple spacing tools 100 may all be attached to the same load, being either the upper or the lower load as described above, or alternatively, some of the multiple spacing tools 100 may be attached to the upper load and other spacing tools 100 be attached to the lower load.

In an alternative embodiment, multiple groups of spacing tools, each comprising at least one spacing tool 100, are used. An operator first uses a group of spacing tools 100 to create and maintain clearance at some locations, and then uses another group of spacing tools 100 to create and maintain another clearance at other locations, and so on. When a group of spacing tools are used, all spacing tools of the group may be attached to the same load, being either the upper or the lower load, or alternatively, some spacing tools 100 in the group may be attached to the upper load and other spacing tools 100 in the group be attached to the lower load.

Although in above embodiments, the attachment block 116 is a magnetic plate used as a fastener for attaching the attachment arm to a ferromagnetic portion of a load, other attachment blocks and fasteners are also readily available. Generally, the fasteners for attaching the attachment arm to a side of a load may be nonintrusive fasteners for attaching the attachment arm to a load without intruding into the load, or intrusive fasteners that penetrate the load to attach the attachment arm thereto. Examples of nonintrusive fasteners include magnet for attaching the first arm to a side of a ferromagnetic load, suction cups for attaching the first arm to a generally smooth side surface of a load, or a wedge, thin plate or spike for inserting in the interface between two vertically neighboring sub-loads. Examples of intrusive fasteners include screws, spikes, sharp extrusions or the like that intrude into a load for attaching the first arm thereto. The particular choice of fasteners depends on the designed use of the spacing tool 100, and may vary in different embodiments. The following shows some examples.

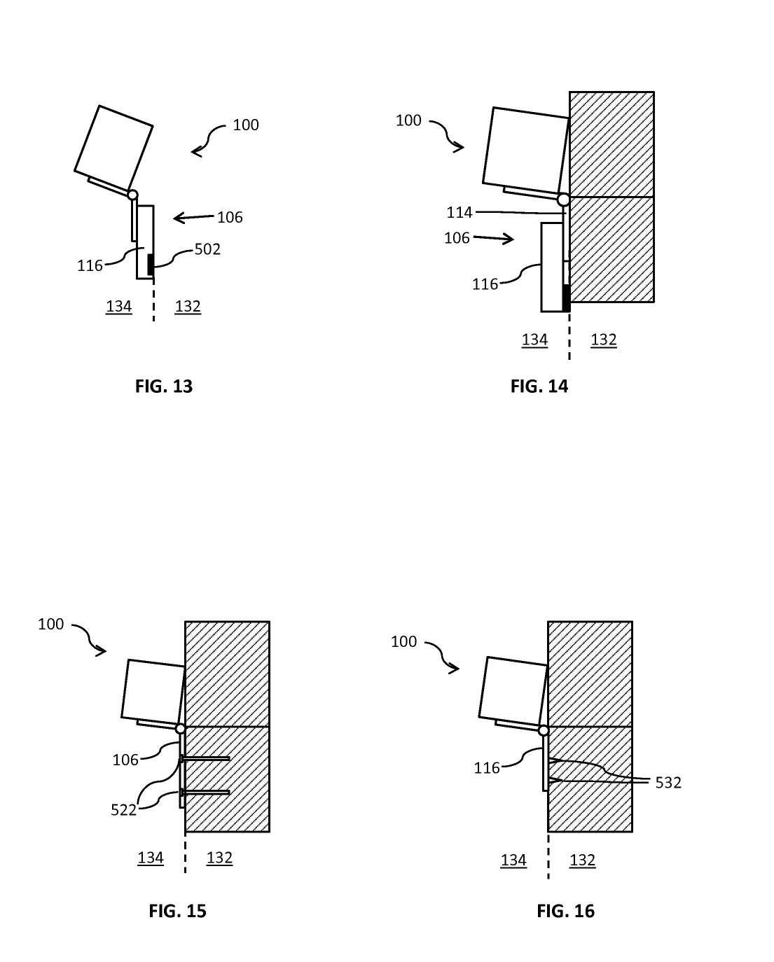

As shown in FIG. 13, in an alternative embodiment, the attachment block 116 is a wood plate having a magnetic metal piece 502 embedded therein as a nonintrusive fastener for attaching the spacing tool 100 to a steel load.

In above embodiments, the attachment leaf 114 is mounted to the attachment block 116 such that a surface of the attachment block 116 is in contact with a load when the spacing tool 100 is attached thereto. As shown in FIG. 14, in another embodiment, the attachment leaf 114 is mounted to the attachment block 116 such that a surface of the attachment leaf 114 is in contact with a load when the spacing tool 100 is attached thereto.

Although in above embodiment, the attachment arm 106 is formed by the attachment leaf 114 and the attachment block 116, in another embodiment, the attachment arm 106 is an integrated component pivotably couple to the spacing arm 104 via the pivot 102.

As shown in FIG. 15, in yet another embodiment, the attachment block 116 is a wood or metal plate. One or more screws or nails 522 may be used as intrusive fasteners for attaching the spacing tool 100 to a load, e.g., a wood load, on its attachment side 132 that is suitable for screwing or nailing.

As shown in FIG. 16, in still another embodiment, the attachment block 116 comprises one or more sharp extrusions or teeth 532 as intrusive fasteners for attaching the spacing tool 100 to a load, e.g., a wood load, on its attachment side 132 that is suitable for penetration.

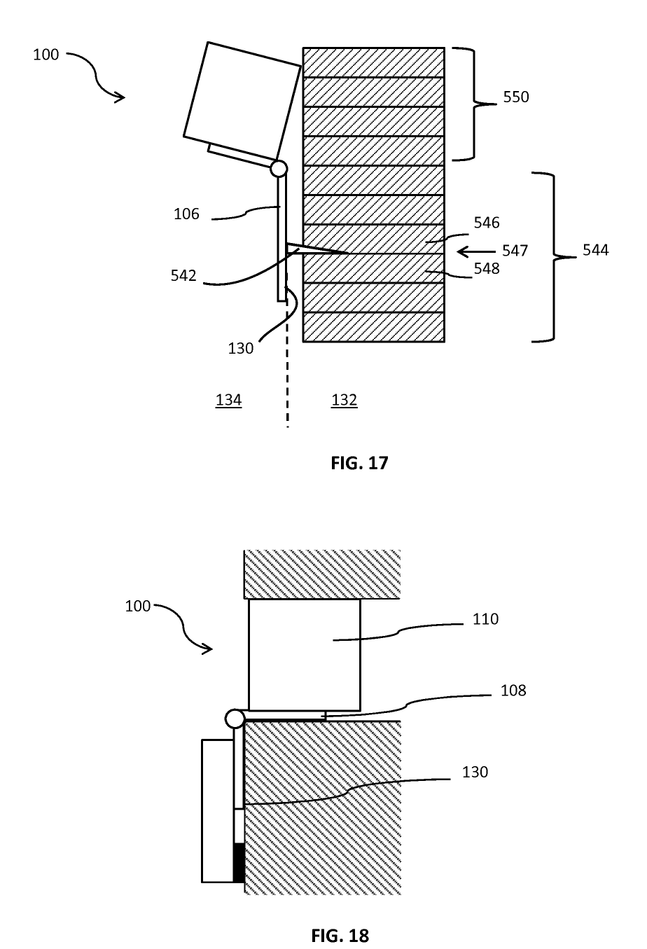

As shown in FIG. 17, in yet still another embodiment, the attachment block 116 comprises a wedge, thin plate or spike 542 as a nonintrusive fastener for attaching the spacing tool 100 to a load 544 by inserting the fastener 542, such as a wedge mount extending from the attachement arm 106, in the interface 547 between two vertically neighboring sub-loads 546 and 548. In this example, the load-attachment surface 130 does not contact the load 544. The upper load 550 comprises a plurality of sub-loads.

In another embodiment, the attachment block 116 comprises a coarse surface as a nonintrusive fastener that uses friction as the attachment mechanism for attaching the spacing tool 100 to a load. The coarse surface may be formed by the attachment block 116, or may be formed by a suitable material such as felt, mounted on the respective load-attachment surface 130 of the attachment block 112. Similarly, opposing hook and loop type fasteners could be used. Fasteners such as suction cups that use vacuum for attaching the attachment arm to a generally smooth surface of a load may be used.

In another embodiment, the spacing tool 100 comprises a replaceable attachment block 116. In this embodiment, various types of attachment blocks as described above may be provided as available parts such that one may select and install a suitable attachment block onto the spacing tool 100 based on the nature of the load.

In above embodiments, the spacing leaf 108 is mounted to the spacing block 110 such that, at the support position, the spacing leaf 108 is generally parallel to the load-attachment surface 130. However, those skilled in the art appreciate that the spacing leaf 108 may alternatively be mounted to other locations of the spacing block 110. For example, as shown in FIG. 18 according to an alternative embodiment, the spacing leaf 108 is mounted to the spacing block 110 such that, at the support position, the spacing leaf 108 is generally perpendicular to the load-attachment surface 130.

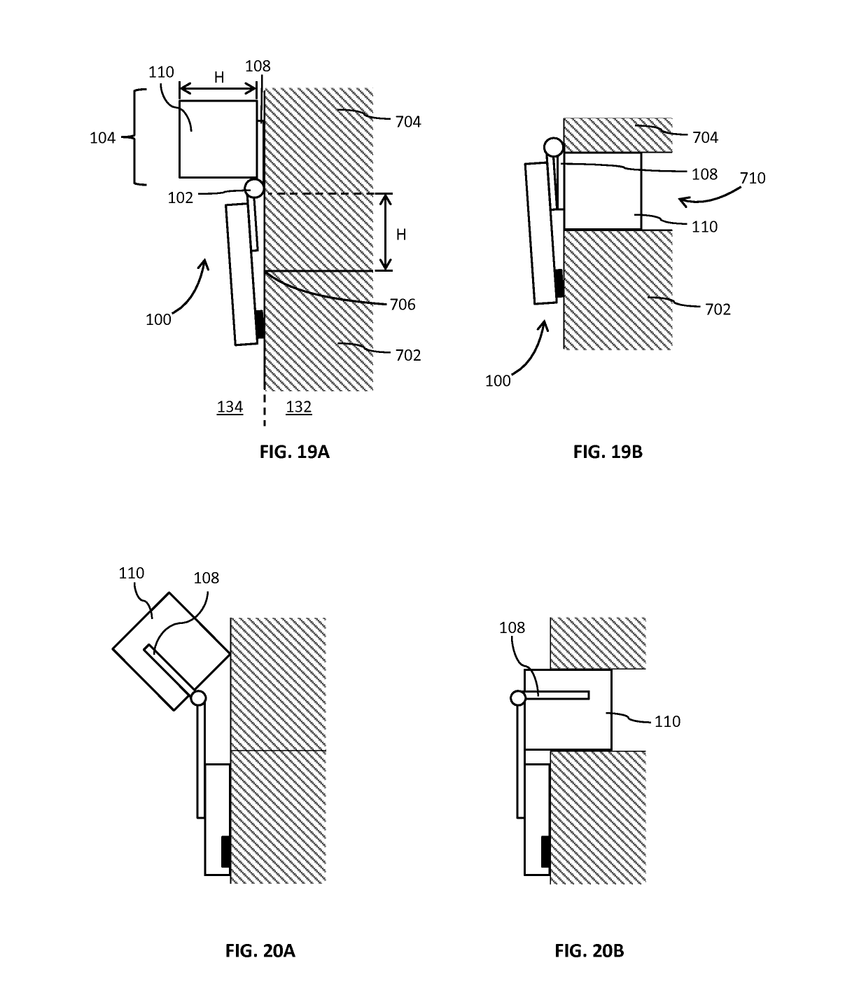

FIGS. 19A and 19B illustrate a spacing tool 100 according to an alternative embodiment. In this embodiment, the spacing block 110 is mounted on the back side of the spacing leaf 108, such that the spacing leaf 108 is closer to the attachment side 132 than the spacing block 110. When in use, the spacing tool 100 is attached to a side surface of a lower load 702 such that the pivot 102 is above the upper edge 706 of the side surface of a lower load 702 at a height of about the height H of the spacing block 110. After the upper load 704 is lifted to a height sufficient for the spacing arm 104 to freely rotate, the spacing arm 104 rotates for about 180° to create a clearance 710 between the upper and lower loads 702 and 704.

In above embodiments, the spacing leaf 108 is mounted to a surface of the spacing block 110. In an alternative embodiment as shown in FIGS. 20A and 20B, the spacing leaf 108 is mounted in the spacing block 110.

In above embodiments, the spacing block 110 is a cube. However, the spacing block 110 may alternatively be of other suitable shapes. For example, the cross-section of the spacing block, as viewed along an axis of the pivot, may be a rectangle, triangle, circle, or other suitable shapes. The first and second support surfaces 124 and 122 of the spacing block 110 may be of the same or different shapes and/sizes, depending on the design in various embodiments.

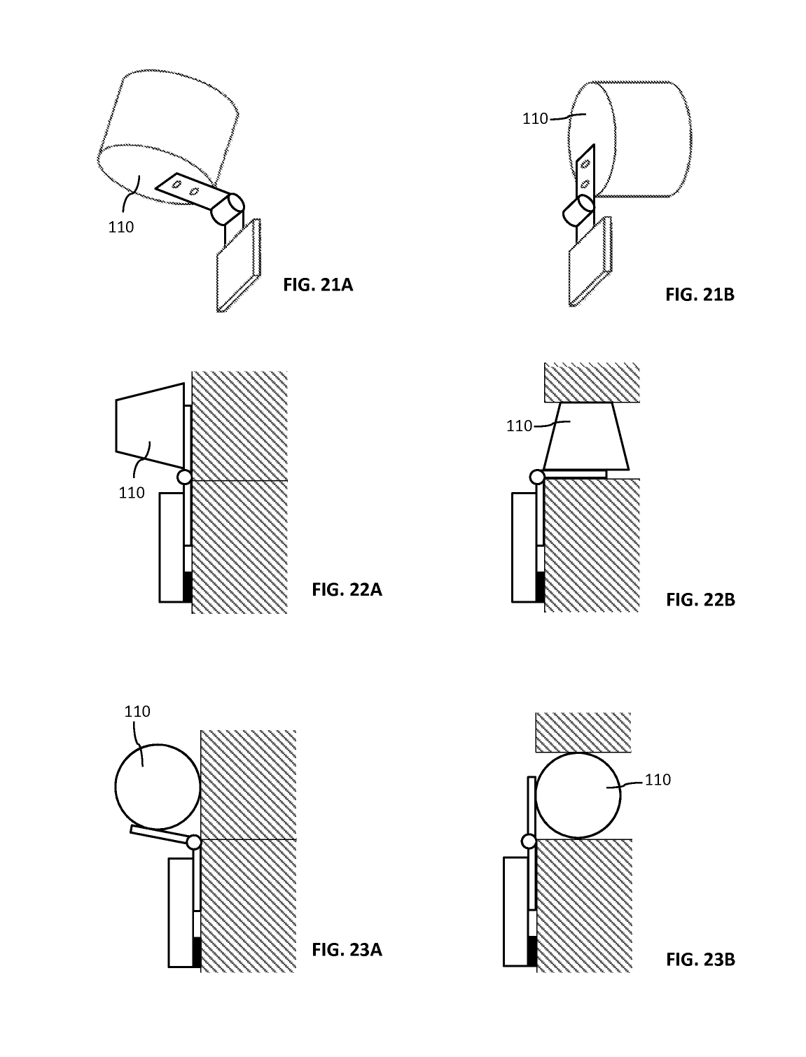

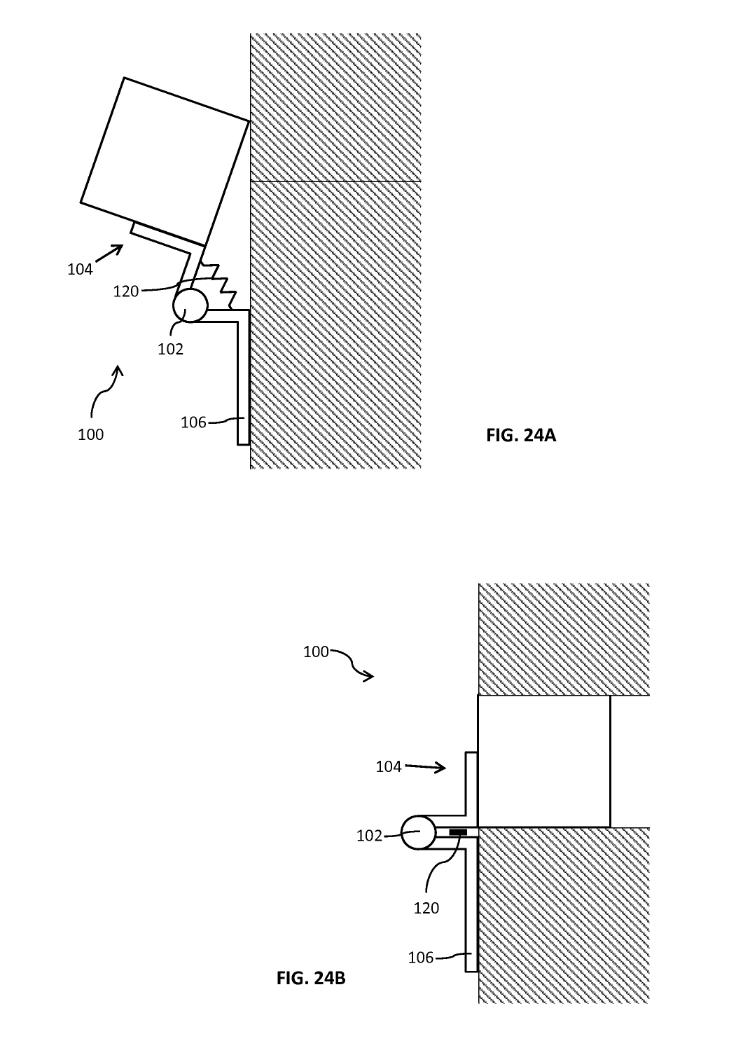

FIGS. 21A to 23B illustrate some examples. FIGS. 21A and 21B illustrate a spacing tool having a cylindrical spacing block 110 at the open and support positions, respectively. FIGS. 22A and 22B illustrate a spacing tool having a conical or frustum spacing block 110 at the open and support positions, respectively. FIGS. 23A and 23B illustrate a spacing tool having a spherical spacing block 110 at the open and support positions, respectively. Those skilled in the art appreciate that other shapes are also available.

In above embodiments, the spacing block 110 is mounted to the spacing arm 104. However, in an alternative embodiment, the spacing block 110 may be an integrated part of the spacing arm 104 manufactured via a suitable means such as welding, molding, or the like, such that a portion of the spacing arm 104 may be considered as the spacing block 110.

Although in above embodiments, the biasing mechanism 120 is mounted in the pivot 102, those skilled in the art appreciate that the biasing mechanism 120 may alternatively mounted in other locations. FIGS. 24A and 24B illustrate a spacing tool 100 in an alternative embodiment. As can be seen, the biasing mechanism 120 in this embodiment is a spring between the spacing arm 104 and the attachment arm 106 with one end being secured to the spacing arm 104 and the other end being secured to the attachment arm 106. The spring 120 biases the spacing arm towards the support position. Thus, in FIG. 24A, the spring is extended in tension, and in FIG. 24B, the spring is relaxed.

Those skilled in the art appreciate that other biasing mechanisms, such as elastics, rubber bands, or the like, are also readily available in alternative embodiments.

What is claimed is:

1. Apparatus for maintaining a clearance created at an interface between vertically stacked first and second loads, the apparatus comprising:
a first arm having a load-attachment surface extending from a pivot; and
a second arm rotatable relative to the first arm about the pivot, the second arm having opposing first and second support surfaces forming a height therebetween, and being normally biased for rotation about the pivot towards the first arm's load-attachment surface between an open position, away from the first arm's load-attachment surface, and a supporting position, towards the first arm's load-attachment surface;
wherein,
the first arm is attachable at a side of the first load with the pivot located at the interface, with second arm biased against the second load when the second arm is at the open position, and
the second arm is rotatable to the supporting position into the clearance created at the interface for maintaining a clearance equivalent to said height between the first and second loads.

2. The apparatus of claim 1 wherein the biasing mechanism is a spring.

3. The apparatus of claim 1 wherein the second arm is a spacing block providing the height for maintaining the clearance.

4. The apparatus of claim 1 further comprising a spacing block secured to the second arm, the spacing block having the opposing first and second support surfaces for forming a height therebetween.

5. The apparatus of claim 4 wherein the spacing block is secured to the second arm with the first support surface biased against the second load when the second arm is at the open position.

6. The apparatus of claim 4 wherein:
the first support surface of the spacing block is secured to the second arm; and
the second arm is biased against the second load when the second arm is at the open position.

7. The apparatus of claim 4 wherein the spacing block is made of a material selected from the group consisting of wood, metal, plastic, rubber and Fibre-reinforced plastics.

8. The apparatus of claim 7 wherein the cross-section of the spacing block, as viewed along an axis of the pivot, is selected from the group consisting of rectangles, triangles and circles.

9. The apparatus of claim 1 wherein the first arm comprises at least one fastener for attaching the first arm to a side of the first or second load.

10. The apparatus of claim 9 wherein the at least one fastener is a nonintrusive fastener.

11. The apparatus of claim 9 wherein the at least one fastener is an intrusive fastener.

12. The apparatus of claim 10 wherein the at least one fastener is selected from the group consisting of magnet, suction cup and wedge.

13. The apparatus of claim 11 wherein the at least one fastener is selected from the group consisting of screw, spike and sharp extrusion.

14. The apparatus of claim 1 wherein at least one of the first and second loads comprises one or more sub-loads.

15. The apparatus of claim 1 wherein at least one of the first and second loads comprises one or more sub-loads, the apparatus further comprising a mount extending from the first arm and spaced from the pivot for securing the load-attachment surface of the first arm against the side of the load with the pivot located at the interface.

16. The apparatus of claim 15 wherein the mount further comprises a wedge for supportable insertion between the sub-loads spaced from the interface.

17. The apparatus of claim 1 wherein the biasing mechanism is in the pivot.

18. The apparatus of claim 1 wherein the biasing mechanism is secured to both the first and second arms.

19. The apparatus of claim 1 wherein the second load is on top of the first load.

20. The apparatus of claim 1 wherein the first load is on top of the second load.

21. A method for maintaining a clearance created at an interface between vertically stacked first and second loads, the method comprising:
providing a first spacing tool having a first arm and a second arm coupled at a pivot for rotation therebetween;
locating the pivot of the first spacing tool at the interface;
attaching the first arm of the first spacing tool at a side of the first load, the second arm of the first spacing tool cocked to an open position biased towards the second load;
separating the first and second loads to form a clearance at least about the location of the first spacing tool;
urging the second arm of the first spacing tool to a supporting position into the clearance; and
reducing the clearance until the upper of the first and second loads is supported upon the second arm of the first spacing tool for maintaining the clearance between the first and second loads.

22. The method of claim 21 wherein said first load is a lower load and said second load is an upper load; and wherein said separating the first and second loads comprising:
lifting the upper load until the second arm of the first spacing tool rotates to the supporting position.

23. The method of claim 21 wherein said first load is an upper load and said second load is a lower load; and wherein said separating the first and second loads comprising:
lifting the upper load and attached first spacing tool until the second arm of the first spacing tool rotates into the clearance.

24. The method of claim 21 further comprising attaching the first arm of the first spacing tool at a side of the first load with intrusive fasteners.

25. The method of claim 21 further comprising attaching the first arm of the first spacing tool at a side of the first load with nonintrusive fasteners.

26. The method of claim 21 wherein the attaching of the first arm is temporary.

27. The method of claim 21 further comprising:
providing a second spacing tool having a first arm and a second arm coupled at a pivot for rotation therebetween;
locating the pivot of the second spacing tool at the interface;
attaching the first arm of the second spacing tool at a side of one of the first and second loads, the second arm of the second spacing tool cocked to an open position biased towards the other of the first and second loads;
separating the first and second loads to form a clearance at least about the location of the second spacing tool;
urging the second arm of the second spacing tool to a supporting position into the clearance; and
reducing the clearance until the upper of the first and second loads is supported upon the second arm of the second spacing tool for maintaining the clearance between the first and second loads.

28. The method of claim 27 wherein the first arm of the second spacing tool is attached to a side of the first load.

29. The method of claim 27 wherein the first arm of the second spacing tool is attached to a side of the second load.

30. The method of claim 27 wherein the first arm of the second spacing tool is attached to a side of one of the first and second loads after the first and second loads have been separated to form a clearance at least about the location of the first spacing tool.

31. The method of claim 27 wherein the first arm of the second spacing tool is attached to a side of one of the first and second loads before the first and second loads have been separated to form a clearance at least about the location of the first spacing tool, and the first and second loads are separated to form a clearance at least about the locations of both the first and the second spacing tools.
